(19) United States
(12) Patent Application Publication
(10) Pub. No.: US 2010/0314922 A1
(43) Pub. Date: Dec. 16, 2010

(54) Seat Fixing System and Hose-Like Fixing Strap

(76) Inventor: Konstantinos Poulakis, Hildrizhausen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/223,919

(22) PCT Filed: Mar. 12, 2007
(86) PCT No.: PCT/EP2007/002135

§ 371 Date: Aug. 13, 2008

(30) Foreign Application Priority Data
Mar. 14, 2006 (DE) 10 2006 011 610.0

(51) Int. Cl. B60N 2/58; B32B 1/08

(52) U.S. Cl. 297/218.2; 428/34.1; 428/36.1

(57) ABSTRACT

The invention relates to a seat fixing system, in particular for passenger seats, such as vehicle or aircraft passenger seats, having a seat part cushion in which or on which at least one linear fixing element is guided, having at least one cover part (14) for the seat part cushion which can be respectively assigned, wherein the cover part (14) has at least one hose-like fixing strap (32) in which at least one further linear fixing element (38) is guided, and having at least one connection element (22) for establishing a connection between the linear fixing elements (18, 38) for the purpose of securing the respective cover part (14) to the seat part cushion which can be respectively assigned, wherein the hose-like fixing strap (32) has a predefinable elasticity in a transverse or inclined direction with respect to the linear fixing elements (18, 38), wherein irregularities in the course of the seam are compensated for.

The invention relates to a seat fixing system, in particular for passenger seats, such as vehicle or aircraft passenger seats, having a seat part cushion in which or on which at least one linear fixing element is guided, having at least one cover part for the respectively assignable seat part cushion, the cover part having at least one hose-like fixing strap in which at least one other linear fixing element is guided, and having at least one connecting element for producing a connection between the linear fixing elements for purposes of fixing the respective cover part on the respectively assignable seat part cushion according to the configuration of features of the preamble of claim 1.

The invention furthermore relates to a hose-like fixing strap according to the configuration of features of claim 9.

In the known seat fixing systems as are readily available on the market, as a linear fixing element a bendable wire is inserted into a U-shaped channel; it is also referred to as a trim wire in the jargon. This wire-shaped fixing element is held in the channel by way of foam intermediate walls which penetrate the channel and holding the fixing wire by surrounding it so that it is held in the channel-like groove retainer of the foam. Instead of the receiving channel it would also be possible in an edge-side fixing retainer of the seat part cushion to hold the linear fixing element by means of a foam-like holding body. The indicated foam parts including the seat part cushion are formed in the conventional manner, preferably as polyurethane molded foam.

To cover the respective seat part cushion there is cover part in the form of a cover fabric, a cover leather, a pertinent artificial leather and the like. Along a definable seam geometry a hose-like fixing strap is fixed on the respectively provided cover part along the seam path, and depending on the seam geometry and the seam length for a seam path also several fixing straps can be fixed on the cover part at a distance. As a further linear fixing element over the length of the hose-like strap another linear fixing element is inserted in the form of another bendable wire which is likewise called a trim wire in the jargon. The trim wire piece which has been inserted laterally into the fixing strap is located along the holding groove with the first linear fixing element which has been foamed in at least partially there and then fixing or connecting of the two linear fixing elements is established by way of connecting elements which encompass the adjacent trim wires in the manner of C-shaped cramps with their two free edges and hold them together in this way. These cramps in practice are placed by hand using a shooting apparatus and the cramp ends which taper relatively to a tip shoot through the material of the hose-shaped fixing strap to overlap the piece of wire which in this instance has been inserted into the strap. The cover part is anchored relative to the foam-like seat cushion part along the desired seam geometry by way of connecting elements in the form of cramps and the seam path is ensured in this way.

In the known solutions, as have been used in practice for years, the hose-shaped fixing straps are made of a textile fabric of warp and weft threads, the fabric types being used here and the material of the weft and warp threads used leading to rigid fixing straps which can hardly stretch. As a result of the rigid arrangement it often moreover occurs that the cramp used as a connecting element does not assume its fixing position which overlaps the wires, but the cramp “leaves” at least one wire of the wire pair, with the result that reworking is necessary there or the seam geometry then has an optically detectable vertical offset which allows the seam path to appear optically unattractive. Overall the anchoring depths obtained as a result of the known rigid solution can be rather different; this leads overall to an unattractive, uneven seam path along the intended anchoring seams. Furthermore it has not been possible to an economically interesting extent to make the known solution fully automatic so that the solution to be fixed by hand is costly overall.

Proceeding from this prior art, the object of the invention is to further improve the known solution such that it leads to elegantly proportioned seam geometries, that it can be economically implemented while avoiding faulty connections, and that it can be fully automatically produced. This object is achieved by a seat fixing system with the features of claim 1 in its entirety and a hose-like fixing strap according to the configuration of features of claim 9.

In that, as specified in the characterizing part of claim 1, the hose-like fixing strap in the transverse or oblique direction to the linear fixing elements has a definable elasticity, in the parallel direction to the linear fixing elements a rigid fixing arrangement is implemented which transversely, that is, at a right angle thereto, or in some other oblique arrangement by way of the definable elasticity, allows vertical equalization such that even for connecting elements which have not been exactly positioned, for example, in the form of the aforementioned cramps or elements, the definable elasticity in the transverse direction of the fixing strap is sufficient to equalize the resulting tolerances and allows the anchoring seam to run visually attractive with a uniform anchoring depth. An unattractive vertical offset along the anchor wire between the base of the seat part cushion and the top of the cover part is thus reliably avoided. It has also been shown that connecting elements, such as cramps, due to the transverse elasticity of the fixing strap, can better penetrate it so that faulty attachments are avoided in this way and the respective connecting element can be positioned with high precision, so that with a low scrap rate it is ensured that the respective cramp-shaped connecting element overlaps the two linear fixing elements by fixing on one another. As a result of the indicated reliable positioning, the solution according to the invention is suited for fully automatic use, in which time-consuming positioning processes by hand can be eliminated. Due to the low scrap rate and practicability in the fixing application, even for installation by hand it can be implemented economically.

In spite of the transverse or oblique direction of the fixing strap which is made elastically resilient, the fixed anchoring seam connection is ensured by way of the respective connecting element, preferably in the form of cramps, and if the fixing strap is made rigid in the longitudinal direction, it accepts the fixing forces to a high degree and at the same time transversely thereto forms the desired equalization relative to making the leveling height or anchoring depth uniform.

When using a hose-like fixing strap according to the configuration of features of claim 9, it consists of a fabric with warp and weft threads, its being characteristically provided for the purposes of the invention that one type of threads consists at least partially of elastic equalization elements which ensures the desired definable elasticity in the transverse or oblique direction. By using this hose-like fixing strap, if necessary, existing seat attachment systems can be retrofitted; this may also take place in the event of a repair in order to arrive in this way at improved wire geometries with a uniform appearance.

Other advantageous embodiments of the solution according to the invention are the subject matter of the other claims.

The seat fixing solution according to the invention is detailed below using one embodiment as shown in the drawings.

The figures are schematic and not to scale.

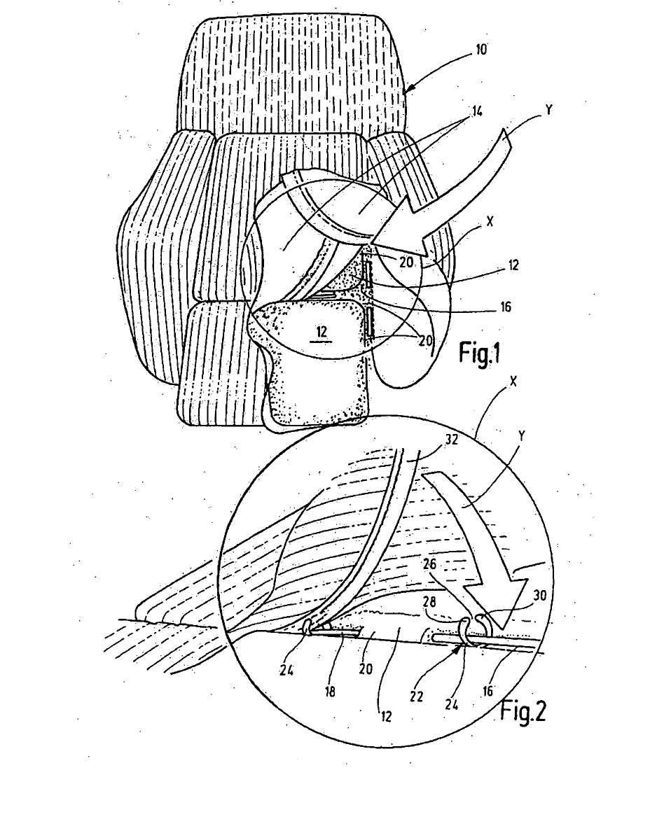

FIG. 1 shows a passenger seat in a perspective plan view;

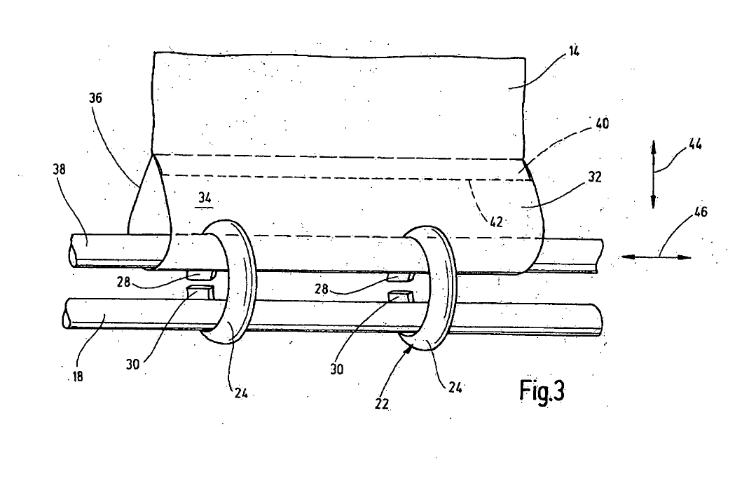

FIG. 2 shows enlarged a detail X according to the circle sector X as shown in FIG. 1;

FIG. 3 shows schematically and not to scale a perspective view of one part of the seat fixing system;

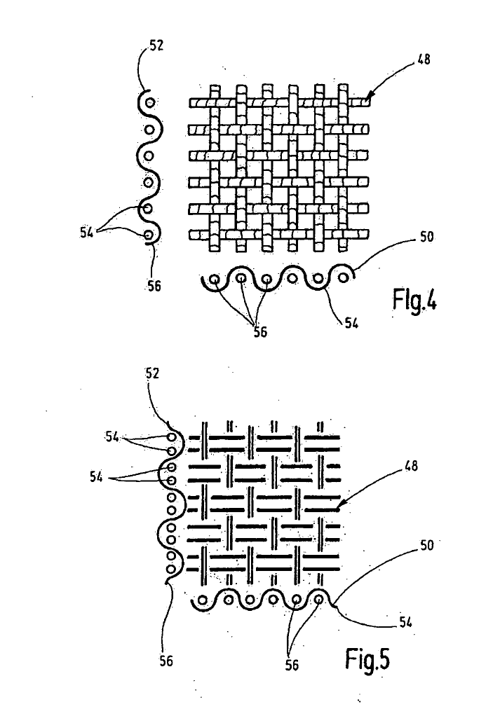

FIGS. 4 and 5 show, in a plan view and edge-side section respectively, the linen fabric used for the hose-like fixing strap as a single or double pick.

FIG. 1 shows in a perspective plan view a passenger seat designated as a whole as 10, as is used, for example, in passenger rail cars. The illustrated seat 10 has a plurality of seal part cushions 12 which generally consist of foamed material, such as polyurethane foam. In particular, the seat back and the armrests, the actual seat part and the leg rest are provided with the pertinent cushions 12 to enhance comfort. Furthermore, for each seat part cushion 12 there is a cover part 14 for covering and protecting the seat part cushion 12. The respective cover part can consist of a conventional fabric, but also of leather, artificial leather, film-like plastic covers and the like.

The seat fixing system according to the invention can be used not only for passenger seats as shown in FIG. 1, but also in the domain of modern vehicle or aircraft passenger seats, including for passenger car, truck and bus seats. Other applications are conceivable for motor coaches and ferries; the use of the seat fixing system is also possible in the seating of concert halls and movie theaters and optionally in the domain of medical and surgical treatment chairs and couches.

As the enlargement X shown in FIG. 2 illustrates, a receiving channel 16 is molded in the edge side region of the seat part cushion 12 for the actual seat part. In the receiving channel 16 which runs in the longitudinal direction of the seat part, a linear fixing element 18 is held which consists of a bendable wire body which is preferably foamed in directly. In order to be able to hold the fixing element 18 in the receiving channel 16, transverse foam walls 20 which overlap the fixing element 18 and fix it in this respect in the receiving channel 16 run at discrete distances within the receiving channel 16. Likewise, at discrete distances from one another and outside the transverse foam wall 20, on the first fixing element 18 as a connecting element 22, there are fixing cramps 24 which point down with their opening side. In the free opening cross section 26 which is formed in this way and which is bordered by the two ends 28, 30 of each cramp 24, a hose-like fixing strap 32 is pressed in from overhead and then the respective cramp 24 is pivoted as a connecting element 22 around the lower wire body 18 until the preferably pointed end 28 penetrates the fixing strap 32 on its two opposite sides 34, 36.

As FIG. 3 shows, within the hose-like cross section of the loop or fixing strap 32 a further linear fixing element 38 is guided which preferably likewise consists of a wire body with a linear characteristic which is flexible. As a result of the bending capacity of the wire bodies 18, 38, in this way anchoring along the path of the seams even around bends can be ensured. If the respective fixing cramp 24 with one of its two free ends 28 or 30 penetrates the hose-like fixing strap 32, this does occur such that the cramp body encompasses or overlaps the upper wire body as the second, other fixing element 38 (cf. FIG. 3). The basic direction of insertion of the hose-like strap 32 into the cramp-like connecting elements 22 is shown in FIGS. 1 and 2 with an arrow Y.

In order to be able to establish a reliable connection between the fixing strap 32 and the cover part 14, as is shown in FIG. 3, it is sewn with its free end along one surface piece 40 of the fixing strap 32. To limit the sewing distance the fixing strap 32 has a preferably red-colored and woven-in identification thread 42 along which the free end of the cover part 14 exits. This boundary seam 42 is also necessary to be able to produce defined ratios of the length of the cover part 14 to the fixing strap 32.

The above described arrangement is conventional and the actual solution according to the invention begins at this point with the hose-like strap 32 which, in the transverse or oblique direction (indicated by the double arrow 44) to the linear fixing elements 18, 38, which run essentially parallel to one another, is provided in the longitudinal direction of the receiving channel 16 (indicated in FIG. 3 with a double arrow 46) with a definable elasticity compared to the previous rigid fabric arrangement of the prior art. Due to this definable elasticity the hose-like fixing strap 32 along the longitudinal direction is designed to be stable and rigid, while conversely in the illustrated transverse direction 44 there is elastic resiliency. The latter allows longitudinal equalization between the fixing elements 18 and 38 to the sewing position along the boundary seam 42 of the hose-like strap 32. This resiliency of the hose-like strap 32 has the advantage that for fixing cramps 24 which have not been exactly set or other irregularities, the hose-like strap can equalize leveling differences in the offset height so that the seam runs in a uniform, elegantly proportioned manner on the top of the cover part 14. It has been shown in practical tests that hereby a level difference of 2 mm to 3 mm can be equalized by way of the elastically resilient hose-like strap 32. This elastic resilience also provides for higher tolerances in the fixing of the cramps 24 being possible, so that overall the illustrated fixing solution according to the invention is suitable for use in fully automatic equipment, in particular automatic sewing machines which mechanically effect the desired seam anchoring.

The hose-like fixing strap 32 could basically also consist of a completely elastomer material with different elastic properties in the longitudinal and transverse direction; especially preferable and economical, however, is the use of a fabric in the form of a textile fabric 48 which has elastic equalization elements in the indicated transverse or oblique direction 44. Different fabrics which are suitable for this purpose are shown, for example, in FIGS. 4 and 5, FIG. 4 relating to a conventional linen weave with a single pick and FIG. 5 a comparable linen weave with a double pick. Viewed in the direction of looking at FIGS. 4 and 5, on the bottom of the respective figure a section 50 through the respective fabric 48 weftwise is shown and in the direction of looking at the figures, to the left of it, is a section 52 through the fabric 48 warpwise. As FIGS. 4 and 5 make clear, the indication “double pick” relative to FIG. 5 should be understood such that relative to the section 52 warpwise one warp thread 56 always overlaps or extends under two weft threads 54 in pairs, conversely, for the single pick configuration as shown in FIG. 4, the respective warp thread 56 always extends under or overlaps one weft thread 54 in an alternating sequence. Relative to the section 50 weftwise, one weft thread 54 in an alternating sequence overlaps the respectively assignable warp thread 56; this also applies analogously to the arrangement as shown in FIG. 4.

The indicated equalization elements are formed from elastomer threads, in particular rubber threads, the respective elastomer thread as a core being surrounded by a plastic jacket, preferably in the form of a polyester protective jacket. According to the linen weaves as shown in FIGS. 4 and 5, their weft threads 54 are the jacketed rubber threads. But it is also possible to change the warp and weft thread direction in the transverse direction; in this instance then the elastic weft threads 56 would be oriented in the direction of the double arrow 44 as shown in FIG. 3. Instead of the immediate transverse direction 44 as shown in FIG. 3, it would also be conceivable to provide elasticity of the fabric threads which run in an oblique arrangement to the longitudinal direction which is identified with the double arrow 46. Furthermore, instead of the linen weave a different type of weave can also be used. In particular, however, it has proven advantageous to form the warp threads 56 from multifilaments, the respective warp threads preferably being formed from a polyester multifilament. But it is also fundamentally possible to provide the fabric 48 of the fixing strap 32 with a finish in order to support its stiffening, for example, in the longitudinal direction 46 of the fixing strap 32. Furthermore, for the respective fabric type situation a 4-shaft weave can preferably be provided. The tubular hose-like strap shown in particular in FIG. 3 can be used as a separate retrofit part, for example, for repairs of known seat systems, in order in this way to replace the known fixing system by the new solution which, as shown, leads to the seam running more attractively; this can be produced moreover economically with fully automatic machinery. Instead of the illustrated elastic rubber threads, it would also be conceivable to provide conventional thread materials at intervals with elastic components or to produce different elasticity properties on the fixing strap 32 with coating technologies. The elastic thread material can also be a so-called bicomponent fiber or other multicomponent fiber with the respective thread component relative to one filament consisting of PES polymers. It has been found that the stretching and the spring-back force of these multicomponent fibers are much better than in conventional mechanically/thermo-plastically textured threads. This fiber material which is built up in a multicomponent manner in this way, in terms of the base filament, is made essentially rigid, and only a downstream thermal treatment process, for example, by placing the fiber material in boiling water for several minutes, results in the elasticity desired for this application being established. This fixing process which leads to elasticity generally cannot be made reversible.

1. A seat fixing system, in particular for passenger seats (10) such as vehicle or aircraft passenger seats, having a seat part cushion (12) in which or on which at least one linear fixing element is guided, with at least one cover part (14) for the respectively assignable seat part cushion (12), the cover part (14) having at least one hose-like fixing strap (32) in which at least one other linear fixing element (38) is guided, and having at least one connecting element (22) for producing a connection between the linear fixing elements (18, 38) for purposes of fixing the respective cover part (14) on the respectively assignable seat part cushion (12), characterized in that the hose-like fixing strap (32) in the transverse or oblique direction to the linear fixing elements (18, 38) has a definable elasticity.

2. The seat fixing system according to claim 1, wherein the hose-like fixing strap (32) is formed from a fabric (48) which has elastic equalization elements in the indicated transverse or oblique direction (44).

3. The seat fixing system according to claim 2, wherein the equalization elements are formed from elastomer threads, in particular rubber threads.

4. The seat fixing system according to claim 3, wherein the respective elastomer thread as a core is surrounded by a plastic jacket, preferably in the form of a polyester protective jacket.

5. The seat fixing system according to claim 2, wherein the fabric (48) consists of a linen weave, with weft threads (54) which are formed from the elastic equalization elements.

6. The seat fixing system according to claim 5, wherein the warp threads (56) of the fabric (48) are formed from multifilament threads, preferably consist of polyester material.

7. The seat fixing system according to claim 1, wherein the respective linear fixing element (18, 38) is formed from a wire body and the respective connecting element (22) consists of C-shaped or U-shaped cramps (24) whose two opposite free ends (28, 30) overlap the wire bodies (18, 38) for producing the connection.

8. The seat fixing system according to claim 7, wherein the hose-like fixing strap (32) can be sewn to the cushion cover part (14) along the anchoring seams.

9. A hose-like fixing strap consisting of a fabric (48) with warp threads (56) and weft threads (54), characterized in that one type of threads (54) consists at least partially of elastic equalization elements.

10. The hose-like fixing strap according to claim 9, wherein the weft threads (54) at least partially have or contain elastic equalization elements, in particular in the form of elastomer threads which are surrounded by a plastic protective jacket.
